(19) United States
(12) Patent Application Publication
(10) Pub. No.: US 2015/0124306 A1
(43) Pub. Date: May 7, 2015

(54) ULTRATHIN NANOSTRUCTURED METALS FOR HIGHLY TRANSMISSIVE PLASMONIC SUBTRACTIVE COLOR FILTERS

(71) Applicant: Lehigh University, Bethlehem, PA (US)

(72) Inventors: FILBERT JOSEPH BARTOLI, Center Valley, PA (US); YONGKANG GAO, Bethlehem, PA (US); BEIBEI ZENG, Bethlehem, PA (US)

(21) Appl. No.: 14/534,900

(22) Filed: Nov. 6, 2014

Related U.S. Application Data
(60) Provisional application No. 61/900,826, filed on Nov. 6, 2013.

(51) Int. Cl. G02B 5/00; G02F 1/23

(52) U.S. Cl. CPC G02B 5/008; G02F 1/23; Y10S 977/834; B82Y 20/00
USPC 359/241; 977/834; 977/781

(57) ABSTRACT

An ultrathin plasmonic subtractive color filter in one embodiment includes a transparent substrate and an ultrathin nano-patterned film formed on the substrate. A plurality of elongated parallel nanoslits is formed through the film defining a nanograting. The nanoslits may be spaced apart at a pitch selected to transmit a wavelength of light. The film is formed of a material having a thickness selected, such that when illuminated by incident light, surface plasmon resonances are excited at top and bottom surfaces of the film which interact and couple to form hybrid plasmon modes. The film changes between colored and transparent states when alternatingly illuminated with TM-polarized light or TE-polarized light, respectively. In one configuration, an array of nanogratings may be disposed on the substrate to form a transparent display system.

### CROSS-REFERENCE TO RELATED APPLICATIONS

The present application claims the benefit of U.S. Provisional Patent Application Ser. No. 61/900,826 filed Nov. 6, 2013, which is incorporated herein by reference in its entirety.

### BACKGROUND OF THE INVENTION

The present invention relates to the field of plasmonic devices, and more particularly to a plasmonic subtractive color filter.

Plasmonic color filters employing a single optically-thick nanostructured bulk metal layer have recently generated considerable interest as an alternative to colorant-based color filtering technologies, due to their reliability, ease of fabrication, and high color tunability. However, their relatively low transmission efficiency (˜30%) needs to be significantly improved for practical applications of the technology.

An improved plasmonic color filter is therefore desired.

### SUMMARY OF THE INVENTION

The present invention provides an ultrathin nano-patterned film configured to form a plasmonic subtractive color filter when illuminated with light. In one configuration, the ultrathin (i.e. optically thin) film is patterned with one-dimensional (1D) nanoslits defining a nanograting. The 1D nanograting is operable to change between colored and transparent states. In other configurations, two-dimensional (2D) nanogrid or nanohole arrays may be provided.

In one embodiment, a plasmonic subtractive color filter includes a transparent substrate, a nano-patterned film formed on the substrate, and a plurality of elongated parallel nanoslits formed through the film. The nanoslits are spaced apart at a pitch. The film is formed of a material having a thickness selected such that, when illuminated by light, surface plasmon resonances excited at top and bottom surfaces of the film interact and couple to form hybrid plasmon modes. When illuminated with light having transverse-magnetic (TM) polarization, the film transmits light of a specific color. When illuminated with light having a transverse-electric (TE) polarization, the film is transparent. The pitch of the nanoslits may be selected to transmit different wavelengths of light, thereby changing the color of the transmitted light. In one non-limiting embodiment, the film may be formed of silver.

In another embodiment, a plasmonic subtractive color filter includes a transparent substrate and a nanograting disposed on the substrate. The nanograting has a thickness selected to be semi-transparent allowing light to be transmitted through solid portions of the nanograting between the nanoslits such that a background image is at least partially visible through the nanograting. A plurality of elongated parallel nanoslits is formed through the film, the nanoslits spaced apart at a first pitch. The film is formed of a material having a thickness selected such that, when illuminated by light, surface plasmon resonances excited at top and bottom surfaces of the film interact and couple to form hybrid plasmon modes. When illuminated with light having transverse-magnetic (TM) polarization, the film transmits light of a specific color. When illuminated with light having a transverse-electric (TE) polarization, the film is transparent.

According to one aspect of the invention, a transparent display system is provided. The display system includes a transparent substrate and a first nanograting disposed on the substrate. The nanograting is formed of a material having a thickness selected such that, when illuminated by light, surface plasmon resonances excited at top and bottom surfaces of the film interact and couple to form hybrid plasmon modes. A plurality of elongated parallel nanoslits is formed through the first nanograting, the nanoslits being spaced apart at a first pitch spacing. When the light has a first polarization, the first nanograting transmits a first transmitted color and retains a first absorbed color, and when the light has a second polarization, the first nanograting is transparent.

In one embodiment, an array of nanogratings may be formed in a pattern on the substrate of the transparent display. The nanogratings may have nanoslits with the same or different pitch spacing to form either a single color or multi-colored display respectively when illuminated with TM-polarized light. When illuminated with light having transverse-magnetic (TM) polarization, the film transmits light of a specific color. When illuminated with light having a transverse-electric (TE) polarization, the film is transparent.

According to another embodiment, a two-dimensional plasmonic filter is provided. The plasmonic filter includes a transparent substrate, a nano-patterned film formed on the substrate, and a periodic array of rectilinear or round nanoholes formed through the film. The film is formed of a material having a thickness selected such that, when illuminated by light, surface plasmon resonances excited at top and bottom surfaces of the film interact and couple to form hybrid plasmon modes. In one embodiment, the filter is tunable to transmit bands of electromagnetic radiation from ultraviolet to microwave wavelengths. In another embodiment, the electromagnetic radiation is in the visible spectrum of wavelengths and the film transmits a specific color.

### BRIEF DESCRIPTION OF THE DRAWINGS

The features of the exemplary embodiments of the present invention will be described with reference to the following drawings, where like elements are labeled similarly.

FIG. 1A is a graphic representation of a semi-transparent nanograting according to the present disclosure which forms a subtractive color filter (SCF) in one embodiment.

FIG. 1B is a perspective view of a nanograting array comprised of nanoslits having different pitch spacings.

FIG. 1C is a graph showing different measured TM transmission spectra for some of the nanogratings in FIG. 1B with different pitch spacings.

FIGS. 2A and 2B are graphs showing correlations between measured experimental results and simulation results respectively of the TM transmission spectra through a nanograting.

FIG. 3A shows optical microscope images comprising a full palette of transmitted subtractive colors produced by nanogratings with nanoslits of different pitch spacings.

FIG. 3B shows graphs presenting simulated and measured experimental transmission spectra of the plasmonic SCFs which correlates with the images of FIG. 3A.

FIG. 3C is a graph showing the correlation between transmission minima observed in the experimental (squares) and simulation (triangles) data.

FIGS. 4A-C are 2D maps of the calculated TM optical transmission (4A), absorption (4B) and reflection (4C) spectra of 30 nm-thick Ag nanogratings as a function of the incident wavelength and grating period, when the duty cycle of the nanogratings is set at 0.5.

FIG. 4D is a map showing electric field (top image) and instantaneous Ez vector (bottom image) distribution at the air/Ag and glass/Ag interfaces of nanogratings (P=340 nm) at the resonance wavelength of 610 nm.

FIG. 5A show an SEM (scanning electron microscope) image (top imagei) of plasmonic SCFs with 2, 4, 6, 8 and 10 nanoslits of period P=350 nm; the middle and bottom images show the optical microscopy images under TM illumination for the case of 2, 4, 6, 8 and 10 nanoslits with periods of 350 nm and 270 nm, respectively.

FIG. 5B show optical microscopy images of cyan (top panel, P=350 nm) and magenta (bottom panel, P=270 nm) plasmonic SCFs with 2, 4, 6, 8 and 10 nanoslits of differing lengths, ranging from 2 μm to 0.3 μm.

FIG. 5C top panel shows a SEM image of a plasmonic SCF mosaic consisting of four different 10×10 μm² color filter squares (nanogratings with different periods of P₁=220 nm, P₂=260 nm, P₃=290 nm, and P₄=350 nm) with zero separation. The bottom panel is the corresponding optical microscopy image (all of the scale bars are 5 μm).

FIG. 6A shows an SEM image of the fabricated plasmonic subtractive spectroscope with grating periods gradually changing from 220 nm to 360 nm (from left to right, with 1 nm increment). The line-width of each nanoslit is fixed at 110 nm, and the scale bar represents 5 μm.

FIG. 6B shows an optical microscopy image of the plasmonic spectroscope illuminated with TM-polarized white light.

FIG. 6C shows an optical microscopy image of a magenta pattern ‘L’ in a cyan background formed by nanogratings with two different periods (P₁=270 nm, P₂=350 nm) fabricated on a 30 nm-thick Ag film, and illuminated with TM-polarized white light. The scale bar is 10 μm.

FIG. 6D shows an optical microscopy image of showing the background object through the same structure, under TE illumination.

FIGS. 7A and 7B show 2D maps of the calculated TM optical transmission and absorption spectra respectively of 30 nm-thick Ag nanogratings as a function of the incident wavelength and grating period, when the line-width of individual Ag lines is fixed at 110 nm. The solid and dash-dotted white curves correspond to the analytical dispersion relations for the lowest and higher order SRSPP modes, respectively. And the dashed white line represents the spectral position of LSPP for a single Ag line with line-width of 110 nm. The solid and dashed black lines in FIG. 7B refer to RA at glass/Ag and air/Ag interfaces, respectively.

FIG. 7C shows electric field distribution at the cross-section of ultrathin Ag nanogratings with the fixed line-width w=110 nm and period of 150 nm, 220 nm, 380 nm; and a single Ag line with the line-width of 110 nm.

FIG. 8 shows a graph comparing measured optical constants of ultrathin (30 nm thick) and bulk (350 nm thick) silver (Ag) films.

All drawings are schematic and not necessarily to scale. Parts given a reference numerical designation in one figure may be considered to be the same parts where they appear in other figures without a numerical designation for brevity unless specifically labeled with a different part number and described herein.

### DETAILED DESCRIPTION OF THE EMBODIMENTS

The features and benefits of the invention are illustrated and described herein by reference to exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

Nano-patterned ultrathin metal films are investigated for use as highly transmissive plasmonic subtractive color filter arrays with sub-micrometer spatial resolution. This represents a highly attractive approach for on-chip color filters, which are vital components for future displays, image sensors, digital photography, projectors and other optical measurement instrumentation. Previous approaches based on traditional colorant filters employ organic dyes or chemical pigments that are vulnerable to processing chemicals, and undergo performance degradation under long-duration ultraviolet irradiation or at high temperatures. Furthermore, highly-accurate lithographic alignment techniques are required to pattern each type of pixel in a large-area array, significantly increasing fabrication complexity and cost. Plate-like dielectric deflectors have recently been proposed, but this scheme suffers from intrinsic limitations due to poor color purity, since the deflector area covers only half of the total area. Nanoplasmonic color filters have been proposed recently as a promising means of overcoming the above limitations.

The well-known extraordinary optical transmission (EOT) phenomenon, observed in a single optically-thick metal film perforated with a periodic subwavelength hole array, has been extensively studied for additive color filtering (ACF) applications over the past decade. Such plasmonic color filters reject the entire visible spectrum except for selective transmission bands that are associated with the excitation of surface plasmon polaritons (SPPs). These EOT transmission bands can be spectrally tuned throughout the entire visible spectrum by simply adjusting geometric parameters, such as the periodicity, shape and size of nanoholes, leading to the wide color tunability. Single-layer nanostructured metals also have significant advantages over colorant-based materials due to their ease of fabrication and device integration, and greater reliability under high temperature, humidity and long-term radiation exposure. Despite these advantages, the low transmission efficiency of hole-array plasmonic ACFs (˜30% at visible wavelengths) remains a bottleneck that limits their commercial applications.

Recently, peak transmission efficiencies of 40˜50% were achieved in the state-of art hole-array plasmonic ACF, but at the expense of spectral bandwidth and color crosstalk. This transmission efficiency is still far below that of commercial image sensors (˜80%, FUJIFILM Electronic materials U.S.A., Inc.). Plasmonic ACFs formed by metal-insulator-metal (MIM) or metal-dielectric (MD) waveguide nanoresonators have achieved high transmission efficiencies of 50˜80%, but are not suitable for low-cost nanofabrication and device integration due to their complex multilayer designs. There is still a critical need for novel plasmonic color filters with both high transmission efficiency and simple cost-effective architectures.

The present invention exploits the counter-intuitive extraordinary low transmission (ELT) phenomenon in a single optically-thin (e.g. 30 nm-thick) Ag metal film patterned with one dimensional (1D) nanogratings, thereby achieving plasmonic subtractive color filters (SCFs) with unusually high transmission of 60-70%. In the present subtractive color filtering scheme, specific colors (i.e. cyan, magenta, and yellow, CMY) are generated by removing their complementary components (i.e. red, green, and blue, RGB) from the visible spectrum. Due to their broad passbands with twice the photon throughput of narrowband ACFs (additive color filters), SCFs have the major advantages of better light transmission and a stronger color signal, and have been successfully used in image sensors for years. Unfortunately, highly efficient plasmonic SCFs have not been previously proposed or realized.

The present work further exploits recent advances in thin-film plasmonic nanostructures, and achieves for the first time, plasmonic SCFs with high transmission efficiency close to that for commercial image sensors. In one embodiment, the nanostructure is an ultrathin plasmonic metal film including nanogratings comprised of a plurality of parallel elongated nanoslits. The transmission minima of plasmonic SCFs, corresponding to the ELT resonances, advantageously can be arbitrarily tuned to specific wavelengths across the entire visible region by simply varying the geometric parameters of nanogratings. Moreover, owing to short-range interactions of SPPs (surface plasmonic polaritons) between nearest-neighbor nanostructures at the ELT resonance, plasmonic SCFs can advantageously efficiently filter colors with only a few (even only two) nanoslits, yielding ultracompact pixel sizes close to the optical diffraction limit (˜λ/2, i.e. 200˜350 nm) that determines the highest achievable optical resolution. Therefore, plasmonic SCFs are capable of providing even smaller pixel sizes than those currently achieved in commercial image sensors (e.g. 1.12×1.12 μm2, Sony Corp.). In addition, plasmonic SCFs with ultrathin 1D nanogratings presented here can be easily applied to two-dimensional (2D) nanostructures (i.e. nanoholes, nanosquares) to achieve polarization-independent operation. It should be noted, however, that the polarization-dependent color filtering function of 1D plasmonic SCFs, which can either filter transverse-magnetic (TM) polarized illumination or function as highly transparent windows under transverse-electric (TE) polarization, makes them highly attractive for next-generation transparent displays.

Accordingly, in one embodiment, a transparent display system is provided for in which an array of ultrathin plasmonic subtractive color filters formed of nanogratings are mounted on a transparent substrate (e.g. transparent glass or polymeric material) and illuminated with TM-polarized light rendering a color in a first color filtering operating mode, or alternatively illuminated with TE-polarized light making the nanograting substantially transparent in a second transparent operating mode. The spacing between nanoslits in each nanograting may be varied to render a different color under TM polarized light, thereby forming a multi-color transparent display system.

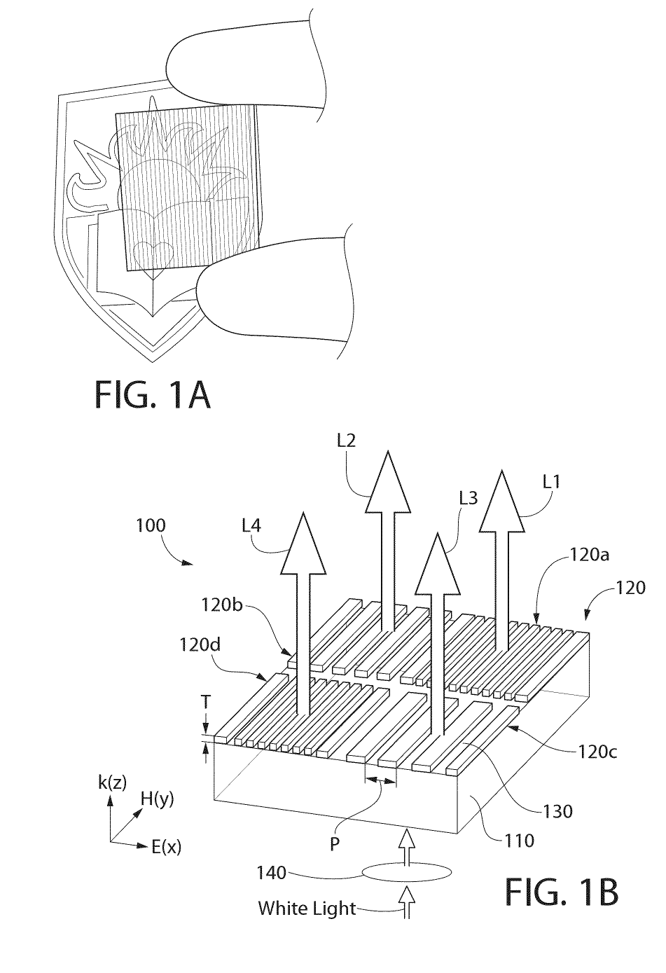

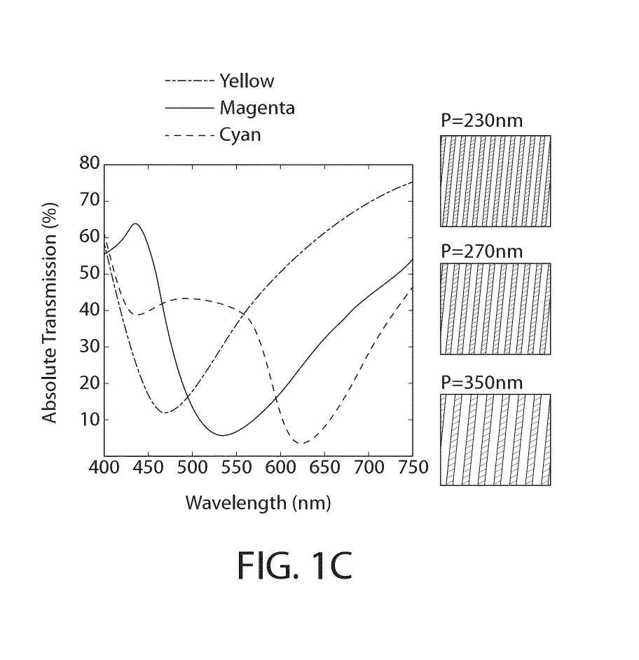

FIG. 1B illustrates an exemplary embodiment of a transparent display system 100. System 100 includes an assembly or structure comprising transparent substrate 110 and an array of ultrathin one-dimensional (1D) nanogratings 120 mounted thereon in a permanent manner. This figure shows four nanogratings 120a, 120b, 120c, and 120d each having a slightly different configuration which transmit and absorb different wavelengths of light, as further described herein. Substrate 110 may be formed of any suitable optically transparent material, such as without limitation glass or polymeric material. The substrate 110 may be rigid or flexible.

Nanogratings 120 may have any suitable size and configuration depending on the intended application. In one representative but non-limiting example, each nanograting may be in the form of a square measuring 10 μm×10 μm. Other sizes and polygonal or non-polygonal shapes may be used. Rectilinear shapes allow a nanograting array to be constructed with very close spacing between adjacent nanogratings.

Nanogratings 120 comprise a metal film having a sufficiently thin thickness T selected to be capable of exciting surface plasmon polaritons (SPP) resonances at the top and bottom surfaces of the nanograting when illuminated with light on the bottom surface. The bottom surface being defined as the surface adjoining the transparent substrate 110 and the top surface is the opposite parallel free surface. This thickness allows the coupling of the top and bottom surface SPP waves through the nanograting necessary to produce the light filtering (i.e. color displayed/exhibited) or alternatively transparent operating modes which may be toggled by changing the polarity of the incident light between TM and TE polarized white light, respectively. If the nanograting is too thick, the coupling effect will not occur. The nanogratings may therefore be considered “ultrathin” making them optically transparent when illuminated with TE-polarized light turning the light filtering mode off.

It should be noted that the thickness T of the nanogratings 120 may vary depending on the wavelength of electromagnetic radiation used to illuminate the nanogratings. Longer wavelength moving towards the infrared and microwave spectral regimes may require thicker films to excite plasmonic resonances. Shorter wavelengths moving toward the ultraviolet and deep ultraviolet regimes may require thinner thickness films than disclosed herein. Accordingly, the thickness T should be selected appropriate to the wavelength of electromagnetic radiation used with either 1D or 2D plasmonic filters for proper transmission of the radiation through the filter.

The nanograting 120 has a thickness T selected to create a semi-transparent structure allowing light to be transmitted through solid portions of the nanograting between the open areas of the nanoslits and around the perimeter wherein a background image or object is at least partially visible through the nanograting albeit in a slight visually muted manner. This is illustrated by the graphic representation in FIG. 1A.

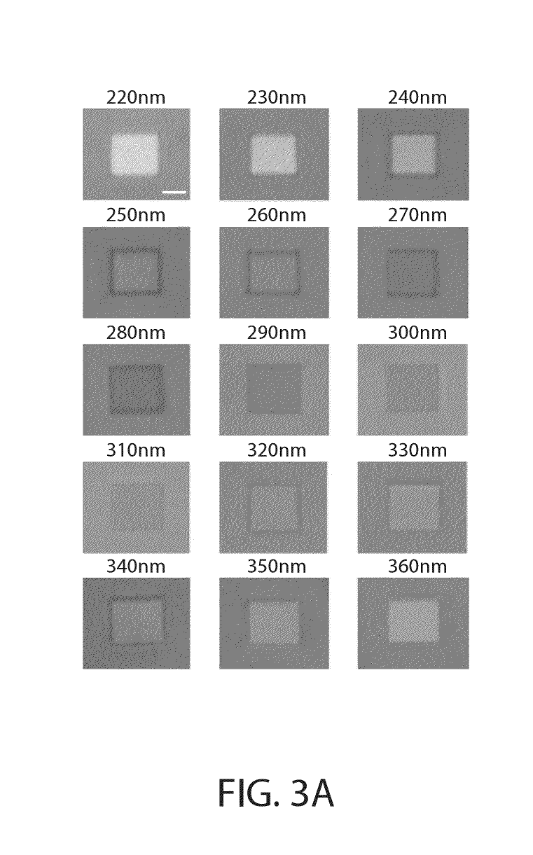

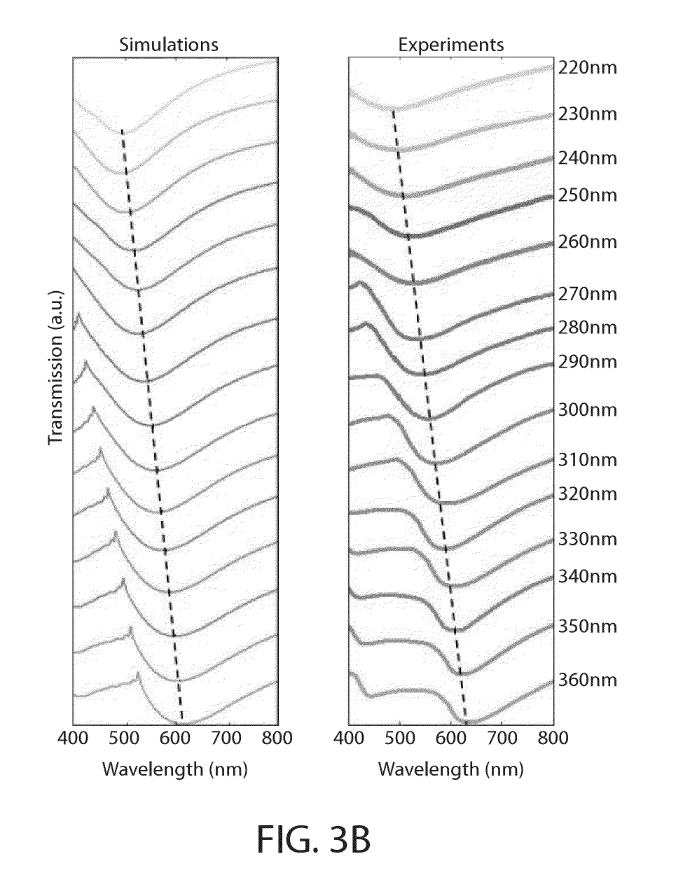

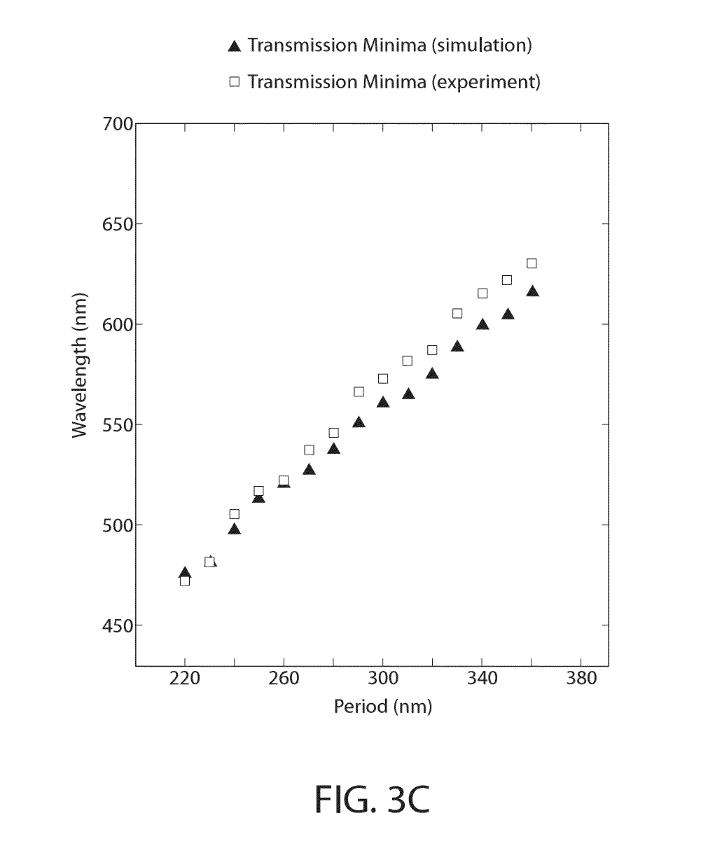

Accordingly, thickness T in one embodiment preferably may be less than 100 nm, and more preferably in some embodiments in a range from and including 10 nm to 50 nm, and most preferably from and including 20 nm to 30 nm to 50 nm based on the results depicted in FIG. 3A further described herein. In one specific non-limiting example, nanogratings 120a-d have a thickness of about 30 nm. The optical constants of ultrathin nanogratings according to the present disclosure are noticeably different from those of an optically thick (e.g, 350 nm) Ag film. It will be appreciated that other suitable thicknesses T may be used so long as surface plasmon resonances may be excited at the top and bottom surfaces of the nanogratings.

Nanogratings 120 may be made of any suitable plasmonic material capable of exciting SPP resonances when illuminated with incident electromagnetic radiation such as light. In one exemplary non-limiting embodiment, the nanogrid preferably may be formed of a metal such as without limitation silver (Ag); however, other suitable conductive non-metallic plasmonic materials may be used such as without limitation graphine or others. Plasmonic materials are distinguishable from lossy and non-plasmonic materials which do not support SPP resonances and are incapable of functioning as a subtractive color filter.

With continuing reference to FIG. 1B, nanogratings 120 may be comprised of a plurality of elongated and parallel linear nanoslits 130 extending in one axial direction between opposite sides of the nanogratings. Nanoslits 130 extend completely through the thickness of nanogratings 120 penetrating the top and bottom surfaces of the nanogratings. In some embodiments, the nanoslits 130 in each nanograting 1200 may be spaced apart in uniform equidistant manner.

Nanoslits 130 may be fabricated by any suitable method. In one embodiment, nanoslits 130 may be formed by focused ion beam milling. Other suitable methods operable at the nm scale levels disclosed herein such as various semiconductor fabrication processes may be used.

To form a subtractive color filter (SCF), nanoslits 130 may be spaced apart at a pitch or period P selected to render different colors when the nanogratings 120a-d are operated as subtractive color filters in the light filtering operating mode. In FIG. 1B, each nanograting 120a-d has differently pitched nanoslits 130. For example, pitches P of 230 nm, 270 nm, and 350 nm will transmit subtractive primary colors yellow, magenta, and cyan light respectively through the nanogratings. The spacing of nanoslits 130 therefore determines the TM polarized light transmission spectra for each nanograting 120a-d, thereby allowing different colors retained or absorbed (i.e. subtracted) to be rendered by the nanogratings. Arrows L1, L2, L3, and L4 in FIG. 1B represent the TM-polarized light transmitted through the nanograting SCFs. L1 represents yellow light (P=230), L2 purple light (P=290), L3 cyan light (P=350), and magenta light (P=270). Accordingly, the full palette of transmitted subtractive colors from yellow to cyan may therefore be revealed in the 1D nanogratings under TM-polarized white light, as the period P of nanoslits 130 in each nanograting changes from 220 nm to 360 nm in 20 nm increments.

FIG. 1C is a graph showing measured TM transmission spectra for yellow, magenta and cyan plasmonic SCFs consisting of 30 nm-thick Ag nanogratings with periods of 230 nm, 270 nm and 350 nm, respectively. The transparent display system 100 in one embodiment therefore operates under a subtractive color model which results from selectively subtracting (i.e. absorbing) some wavelengths of light and allowing others to be transmitted through the nanogratings. The color that a surface displays depends on the wavelength of the visible spectrum in white light (comprising red, blue, and green wavelengths) which is absorbed and remains visible depending on the period P of the nanoslits 130.

With continuing reference to FIG. 1B, polarized white light is incident on transparent substrate 110 side of the transparent display structure. In one embodiment, the light source may be halogen; however other type sources may be used. To selectively toggle between the color filtering and transparent operating modes, the incident white light comprising red, blue, and green wavelengths are transmitted through a polarizing filter 140 operable to switch between TM and TE polarizations. Any suitable polarizing device may be used.

The transparent display structure of system 100 may be formed by any suitable method used in the art. In one example, a 30 nm thick Ag nanograting 120 may be first fabricated on a glass substrate 110 The nanoslits 130 in nanograting 120 may be fabricated to the desired size and configuration by focused ion beam milling (e.g. FEI Dual-Beam system 235) from a solid substantially planar Ag film which was first deposited by any suitable film formation process onto the glass top substrate 150. Film formation systems such as e-beam evaporation (e.g. Indel system) or other methods may be used. Other suitable methods used in the art may be used to fabricate the nanogrid 170 and nanoslits 130 therein including standard semiconductor type fabrication techniques, for example without limitation optical photoresist lithography, nano-printing, nano-injection molding, and others. Accordingly, the invention is not limited by the manner of fabricating nanograting 120.

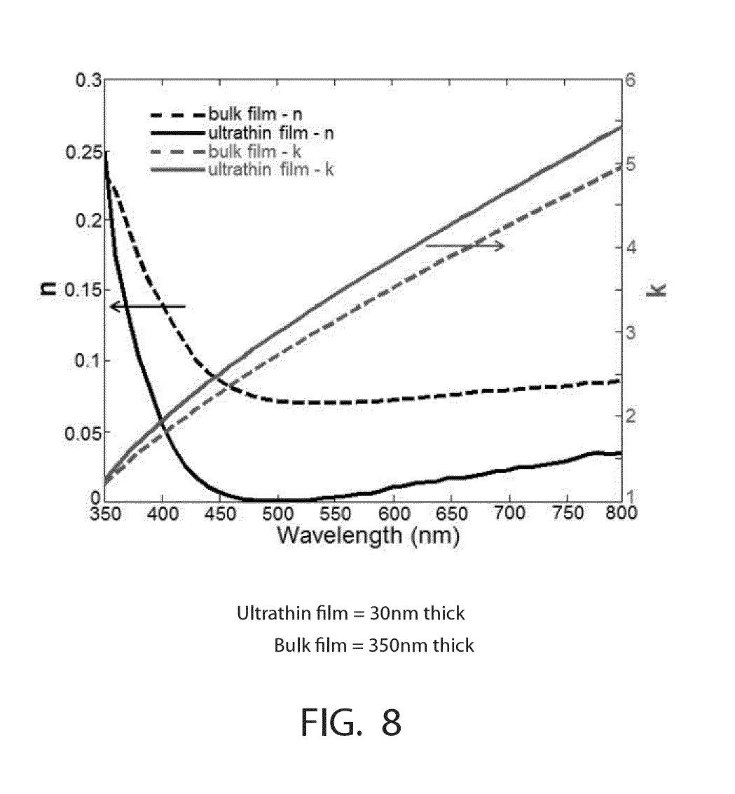

FIG. 1A is a graphic representation of a nanograting 120 actually constructed by the inventors of a nominal ultrathin 30 nm-thick Ag film with nanoslits 130 deposited on a standard microscope glass slide that serves the transparent substrate 110. The background pattern can be clearly seen through the semi-transparent Ag film. The actual Ag film thickness was measured to be 29.8 nm. The optical constants of the ultrathin film were measured and are noticeably different from those of an optically thick (e.g. 350 nm) 2D Ag film. FIG. 8 is a graph showing the measured optical constants of ultrathin (30 nm thick) and bulk (350 nm thick) Ag films.

The schematic diagram of plasmonic SCFs formed of nanogratings is shown in FIG. 1B, where 1D nanogratings 102a-d with different periods are patterned on the ultrathin Ag film. For normally incident light polarized along the x-direction (TM polarization), the absorption and reflection are enhanced at the resonance wavelength, leading to a transmission minimum, which surprisingly was opposite to the well-known EOT phenomenon that exhibits enhanced transmission peak at the resonance wavelength in optically-thick nanostructured metal films. By simply varying the period of nanopatterns on the ultrathin metal film, arbitrary colors may be subtracted from broadband white light. The key features of the present nanograting design, which contains only a single ultrathin nanopatterned metal layer, are their simple design rules, ease of fabrication, and scalable throughput by means of large-area nanofabrication methods, such as nanoimprint lithography or optical interference lithography. For a proof-of-principle experiment, nanogratings with different periods were fabricated using focus ion beam (FIB) milling. The right column in FIG. 1C is a graphic representation of actual scanning electron microscopy (SEM) images of the fabricated nanogratings with three different periods (230 nm, 270 nm and 350 nm). The duty cycle of nanogratings was set as 0.5 for convenience. FIG. 1C presents measured transmission spectra of the cyan (P=350 nm), magenta (P=270 nm) and yellow (P=230 nm) plasmonic SCFs constructed of ultrathin nanogratings 120 according to the present disclosure under TM-polarization, with transmission minima that are positioned in red, green, and blue spectral regions, respectively. Note that the observed absolute peak transmission, 60˜70% in the visible region, represent an unusually high transmission efficiency for such structures. The full-widths at half maximum (FWHM) of the stopbands are approximately 100 nm for yellow and cyan SCFs, and 160 nm for magenta SCFs, which are comparable to the passband width for state-of-art plasmonic ACFs (additive color filters).

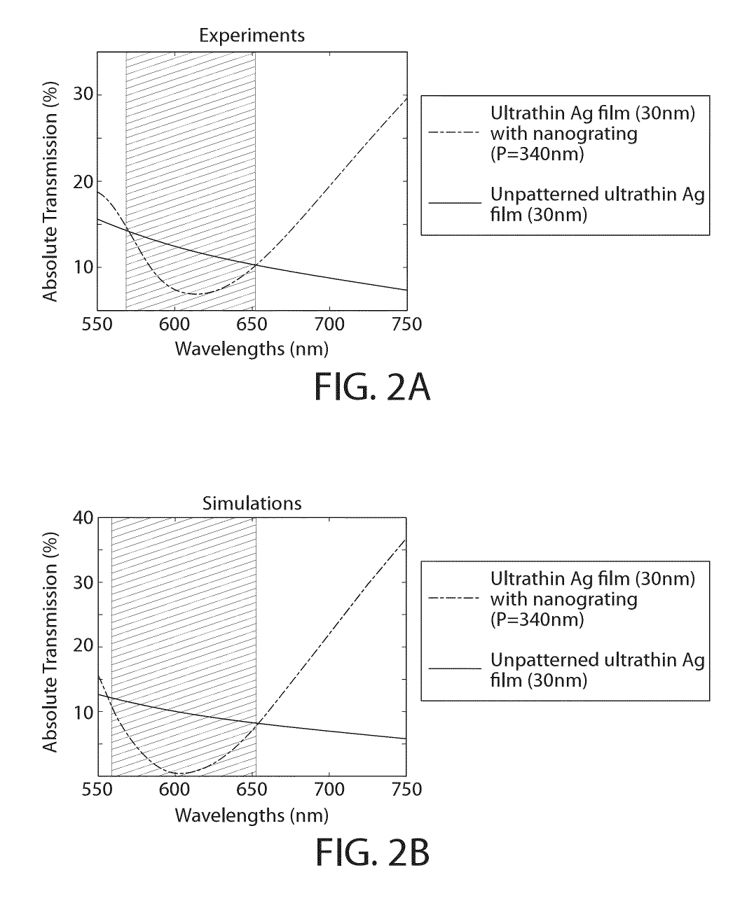

The solid and dashed curves in FIGS. 2A-B represent the measured transmission spectra under TM-polarized illumination through 30 nm-thick Ag films with and without 340 nm-period nanogratings 120, respectively. The intriguing characteristic of ELT phenomenon is that the optical transmission through the ultrathin Ag film patterned with nanogratings (dashed curves) is lower than that through the unpatterned Ag film (10˜12%, solid curves) over a broad spectral range (shaded region), even though 50% of the highly-reflective Ag is removed in the nanogratings compared to the unpatterned Ag film. The 6% experimental transmission minimum centered at a wavelength of 610 nm is consistent with the finite-difference time-domain (FDTD) simulations (dashed curves). It should be noted that the calculated minimum transmission is close to zero (0.39%), indicating that the incident light can in principle be completely blocked by the ultrathin nanogratings at the resonance wavelength. Differences between the experimental and numerical results can be attributed to the nonparallel incident light employed in the measurement, nanofabrication defects, surface roughness, and finite periodicity. The simulated transmission (T), reflection (R) and absorption (A) for this 30 nm-thick Ag nanograting with P=340 nm are 0.39%, 85.5% and 14.11%, respectively, at the ELT resonance wavelength. Note that T=10.9%, R=82.86% and A=6.24% for the case of the unpatterned film. The increased reflection and absorption result in the suppression of the transmission in ultrathin Ag nanogratings.

In order to achieve a full palette of subtractive colors that spans the entire visible region, the period of nanogratings was varied from 220 nm to 360 nm in 10 nm increments. All the fabricated nanogratings have the same dimensions of 10×10 μm². FIG. 3A shows the corresponding optical microscope images (from yellow to cyan) of fifteen square-shaped plasmonic SCFs illuminated by TM-polarized white light. The numbers (in nanometers or nm) beside each image shows the corresponding nanoslits pitch spacing. Although the colors are not evident in the black and white rendering of this figure, the top row is in the yellow color family with yellow at left moving towards orange at right, the row beneath that is in the magenta color family, the row beneath that is in the purple color family, the last two rows beneath that are in the cyan color family. At the same time, these same nanostructures strongly transmit TE-polarized light, which distinctly contrasts with that of previous optically-thick plasmonic ACFs or wire-grid polarizers. The polarization-dependent color filtering effects in plasmonic SCFs arise from the polarization-dependent excitation of SPPs in 1D nanogratings. This unique feature indicates that the proposed plasmonic SCFs can function either as SCFs or highly transparent windows under different polarizations, which has potential applications in transparent displays.

FIG. 3B presents transmission spectra of the plasmonic SCFs, exhibiting transmission minima that are tuned across the visible spectrum by varying the period from 220 nm to 360 nm. FDTD simulations (i) agree reasonably well with the experimental results (ii). The trend lines (dashed vertical lines) approximate the variation of transmission minima from 470 nm to 620 nm as the periods vary from 220 nm to 360 nm. The variation of the transmission minima with period are further illustrated in FIG. 3C, showing a nearly linear relation between the resonance wavelengths and nanograting period. That arbitrary subtractive colors can be obtained by simply varying the grating period is highly advantageous. This could extend the operational range of conventional colorant color filters that do not scale well to more than three spectral bands, making them especially attractive for multispectral imaging applications.

Physical Mechanisms Responsible for Extraordinary Low Transmission (ELT)

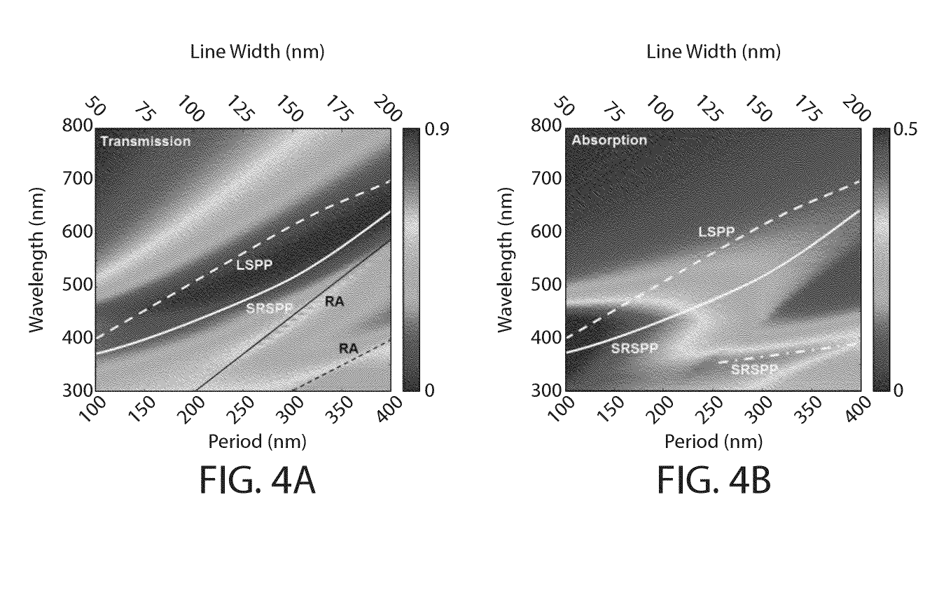

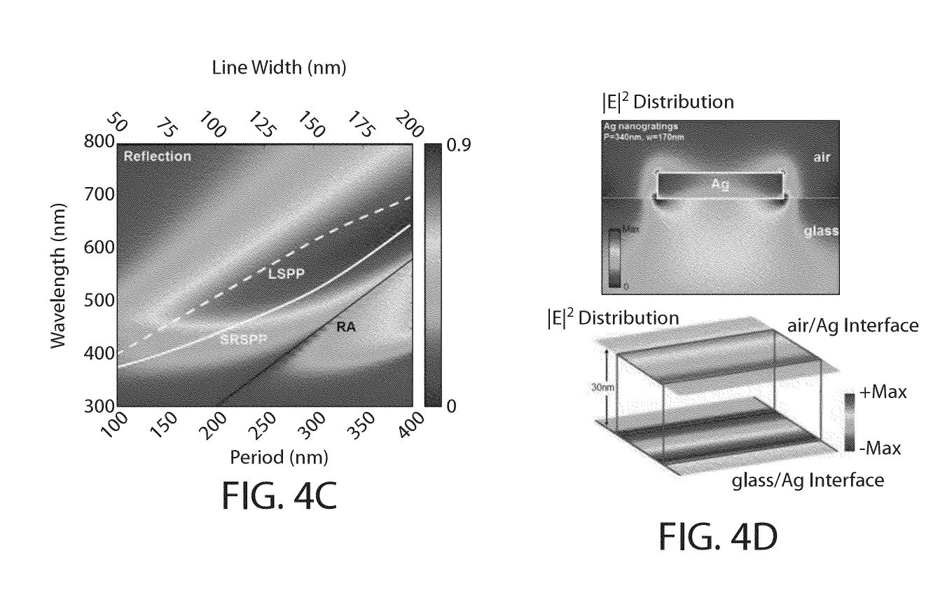

The phenomenon of ELT in ultra-thin nanopatterned metal film has been the subject of numerous fundamental investigations since 2009. Although there is a general agreement that SPPs play a crucial role in ELT, recent studies have reported different conclusions regarding whether the suppression of transmission is due to the excitation of short-range SPPs (SRSPPs) or localized SPPs (LSPPs). To elucidate the physical mechanisms underlying the ELT phenomenon, we model the optical properties of ultrathin Ag nanogratings via FDTD simulations. 2D maps of the calculated transmission, absorption and reflection for 30 nm-thick Ag nanogratings are shown in FIGS. 4A-C, respectively, as a function of the incident wavelength and grating period. The duty cycle of nanogratings was set as 0.5. The low-transmission band in FIG. 4A shifts to longer wavelengths as the grating period increases.

The resonance wavelengths of the lowest and higher orders SRSPP modes were calculated using analytical dispersion relations, and plotted in FIGS. 4A-C as solid and dash-dotted white curves, respectively. The contribution of LSPP modes was estimated by calculating the spectral positions of LSPPs for single Ag lines (with the same line-width as that of nanogratings). These are represented by the dashed white line in FIGS. 4A-C. Both SRSPP and LSPP modes exhibit spectral dependence on the period (line-width) that is in reasonable agreement with the FDTD simulations. The simulated transmission minima and absorption/reflection peaks, which vary continuously from 400 nm to 650 nm in wavelength as the period increases from 100 nm to 400 nm, are located in between the dashed (LSPP) and solid white curves (SRSPP). This indicates that LSPP and SRSPP modes both contribute to the ELT effect for the range of geometric parameters considered here. A narrow transmission peak attributed to Rayleigh-Wood anomalies (RA) at the Ag/glass interface (solid black line) ranges at shorter wavelengths. The dashed RA line in FIG. 4A represents the RA at the air/Ag interface, which matches well with a transmission peak in the ultraviolet region (300˜400 nm). FIGS. 4A-C show that for the range of geometric parameters considered in FIG. 3, the transmission minima are primarily attributed to enhanced absorption and reflection in the Ag nanograting, due to the excitation of SRSPP and LSPP modes.

To further characterize the electromagnetic modes at the resonance wavelength, we calculate the electric field (i) and Ez vector (ii) distributions at the air/Ag and glass/Ag interfaces for ultrathin nanogratings (P=340 nm) at a wavelength of 610 nm. The results are plotted in FIG. 4D, showing the excitation of propagating SPP modes. The enhanced electromagnetic field (i) is strongly confined at the Ag/glass interface, with a decay length of hundreds of nanometers into the glass substrate. In addition, the antisymmetric Ez patterns (ii) correspond to a symmetric surface charge distribution, further demonstrating the propagating SPP modes with the characteristics of SRSPPs. Additional simulations reveal that the electromagnetic modes in a relatively broad spectral region close to the transmission minimum have similar Ez patterns. The electric field distribution (i) also shows LSPP modes (with a decay length of tens of nanometers) at the corners of nanogratings. Accordingly, the resonant electromagnetic modes in the ultrathin Ag nanogratings (duty cycle 0.5) have the properties of hybrid LSPP and SRSPP modes.

The FDTD simulations performed above, systematically varying geometric parameters such as periodicity and line-width (duty cycle 0.5), help to clarify the underlying physical mechanisms for ELT in ultrathin Ag nanogratings, and illustrate the relative contributions of the different electromagnetic modes (SRSPPs, LSPPs, and RA). For the range of geometric parameters used in our experiments (periods ranging from 220 to 360 nm), ELT results from the excitation of both SRSPP and LSPP modes that lead to enhanced absorption and reflection.

High-Resolution Plasmonic Subtractive Color Filtering and Applications

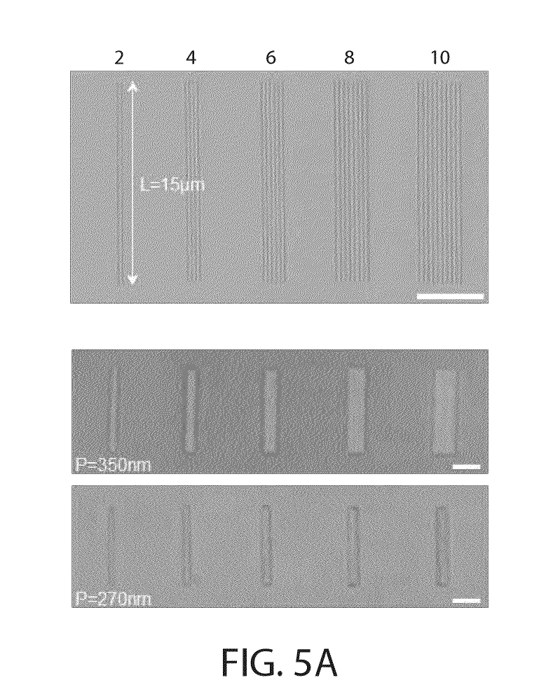

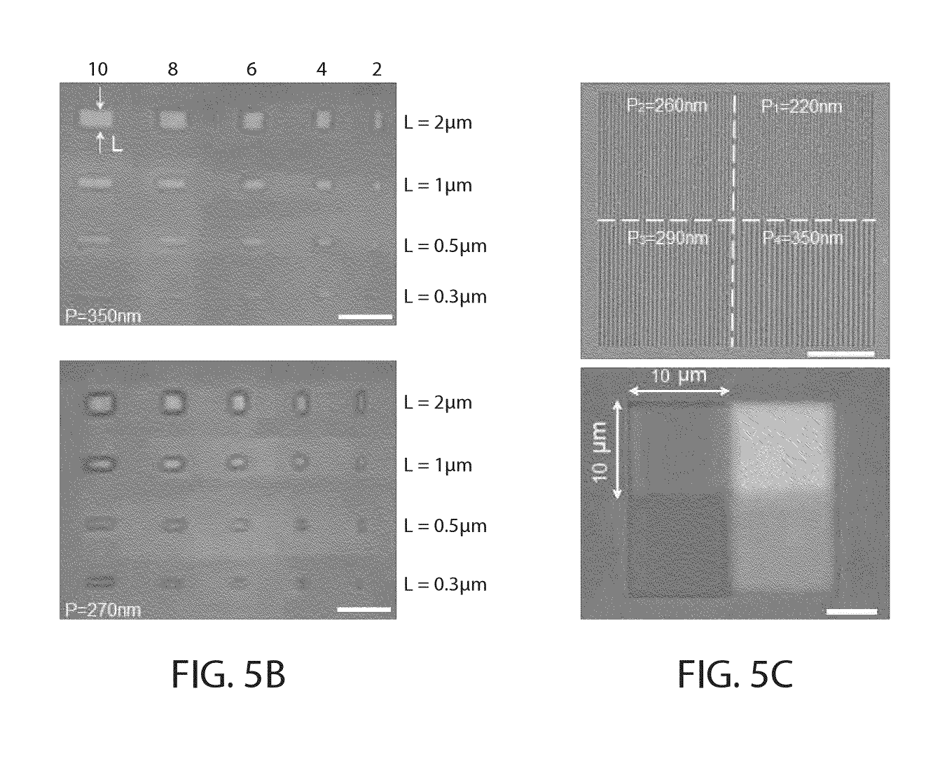

The functional relationship between plasmonic subtractive color filtering and feature size is now discussed, to explore the achievable SCF spatial resolution and determine the smallest pixel size for imaging applications. FIG. 5A shows cyan and magenta plasmonic SCF arrays consisting of 2, 4, 6, 8 and 10 nanoslits, all with the same length of 15 μm and a duty cycle of 0.5. The nanoslit periods for the cyan and magenta SCFs are 350 nm and 270 nm, respectively. Surprisingly, the SCF arrays with only two nanoslits still exhibit distinct cyan or magenta colors. The nanoscale dimensions for the cyan and magenta filters with two nanoslits (525 nm and 405 nm, respectively) are close to the diffraction limit of visible light (λ/2, 200˜350 nm). The electric field distributions were calculated for the cyan and magenta double-nanoslit structures. These simulations indicate that both SRSPP and LSPP modes are excited in these nanoscale doublet structures and contribute to the observed colors.

Additionally, FIG. 5B shows a series of cyan and magenta SCF structures fabricated with 2, 4, 6, 8 and 10 nanoslits, with nanoslit lengths of 2, 1, 0.5, and 0.3 μm. The microscope images show that color filtering persists in the plasmonic SCFs with a few nanoslits even when the length of nanoslits is decreased to 300 nm. Therefore, plasmonic SCFs are capable of generating much smaller pixel sizes (˜0.5×0.3 μm²) than the smallest pixels achieved today in commercial image sensors (e.g. 1.12×1.12 μm², Sony Corp.). A unique feature of the plasmonic SCFs is their ability to advantageously perform color filtering on the nanometer scale, with much simpler and thinner structures than that of previous multilayered designs.

Additionally, FIG. 5C shows a 2×2 array of plasmonic SCFs fabricated to examine the effect of spatial crosstalk between adjacent structures on transmitted colors. This color filter mosaic consists of four different square-shaped (10×10 μm2) plasmonic SCFs fabricated by FIB with zero separation. The four SCFs are composed of nanogratings with different periods (P¹=220 nm, P²=260 nm, P³=290 nm, and P⁴=350 nm), as shown by the SEM images in the top panel of FIG. 5C. The optical microscope image of the color filter mosaic under TM-polarized white light is shown in the bottom panel of FIG. 5C. Four distinct subtractive colors can be clearly resolved even at the center corner or boundaries of adjacent filters, indicating that the proposed plasmonic SCFs can be applied to high-resolution color filter arrays widely used in imaging sensors or color displays. The image blurring at boundaries arises from effects of light diffraction and the limited optical resolution of the microscope.

Spectral imaging combines two normally distinct techniques: imaging, in which the light intensity is typically measured at each pixel in a two dimensional array, and spectroscopic measurements of intensity as a function of wavelength, thus generating a three-dimensional multispectral data set I(x, y, λ). Applications of spectral imaging range from biological studies to remote sensing. However, this technique typically employs bulky filters and scanning interferometers to acquire a complete spectrum at each pixel, since conventional miniature color filter arrays are normally limited to three spectral bands (i.e. RGB—red, green, blue or CMY—cyan, magenta, yellow). Recent studies of plasmonic miniature color filter arrays with wide color tunability were conducted to enable direct recording of spectral image data in a single exposure without scanning. These included plasmonic photon sorters (which had a limited transmission efficiency of 1.5˜15%) and an ultra-compact plasmonic spectroscope (composed of complex MIM nano-resonators). In the current work, we employ plasmonic SCFs array to achieve a compact plasmonic subtractive spectroscope.

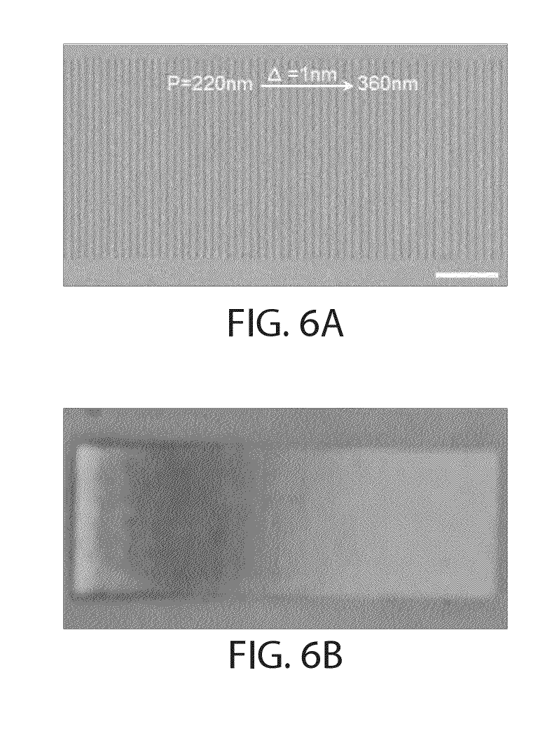

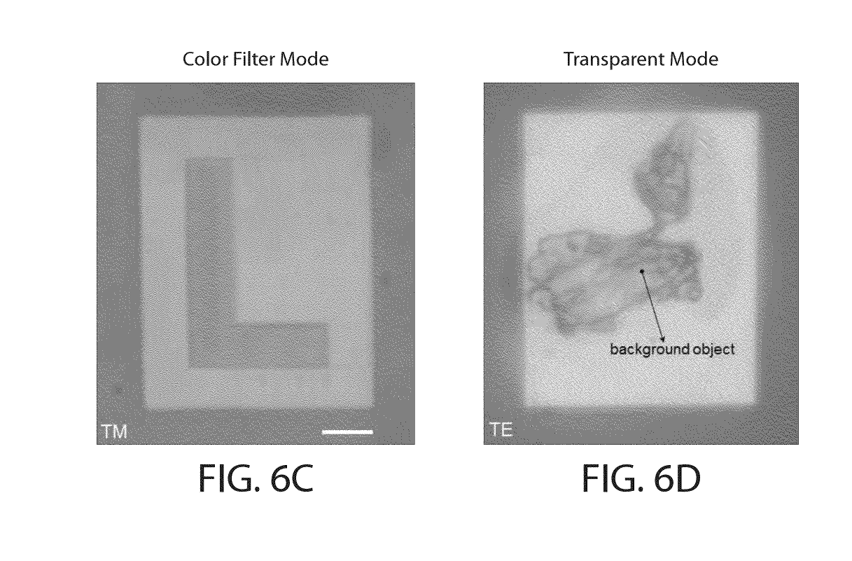

FIG. 6A shows a SEM image of the fabricated device consisting of ultrathin nanogratings with periods gradually changing from 220 nm to 360 nm in increments of 1 nm and a fixed nanoslit width of 110 nm. When illuminated with TM-polarized white light, the structure produces a rainbow stripe of continuous subtractive colors, as shown in FIG. 6B. This miniature plasmonic subtractive spectroscope can disperse the entire visible spectrum into component colors within a distance of a few micrometers, which is orders of magnitude smaller than the conventional prism- or grating-based devices for multispectral imaging. This plasmonic subtractive spectroscope has a much higher transmission efficiency (60˜70%), a simple scheme consisting of a single ultrathin nanopatterned metal film, which is five to ten times thinner than that of previous designs.

Multiple subtractive color filters (SCFs) each formed of nanogratings 120 according to the present disclosure may be combined in various shaped arrays and patterns on one or more substrates 110 to form transparent displays. When illuminated with incident transverse-electric (TE) polarization light, the SCFs are transparent allowing one to see through the display which becomes a transparent window. When illuminated with incident transverse-magnetic (TM) polarized light, the SCFs will render color objects on the display having a pattern coinciding with the pattern of the SCF array. The SCFs may be selectively positioned on the substrate 110 of the display to yield enumerable object shapes, patterns, or characters, which may include without limitation alphanumerical characters, other indicia, geometric shapes, artistic shapes or works of art, and others. In some embodiments, SCFs (i.e. nanogratings 120) having nanoslits 130 with different pitches may be combined to form multicolored objects when illuminated. It should be noted that SCFs according to the present disclosure may be placed on the display with essentially no space between when observed with the naked eye.

FIG. 6A is an SEM (scanning electron microscope) image of the fabricated plasmonic subtractive spectroscope formed of nanogratings 120 with grating periods gradually changing from 220 nm to 360 nm (from left to right, with 1 nm increment). The line-width of each nanoslit is fixed at 110 nm, and the scale bar represents 5 μm. FIG. 6B is an optical microscopy image of the plasmonic spectroscope illuminated with TM-polarized white light.

FIG. 6C shows an optical microscope image of a magenta character “L” in a cyan background, formed when nanopatterns are illuminated with TM-polarized white light. The letter “L” may be constructed by nanogratings with a period of P=270 nm, and the cyan background by nanogratings with a period of P=350 nm. Two distinct colors are clearly preserved even at the sharp corners and boundaries between the two different patterns, indicating the high-resolution color filtering capability. Under TE-polarized illumination, on the other hand, the same structure remains a transparent window, through which we can clearly observe a background object with its detailed features, as shown in FIG. 6D. This is quite different from that of the plasmonic nanoresonator ACFs, for which the TE-polarized incident light is totally blocked. Therefore, the ultrathin plasmonic SCFs can function as color filters as an alternative to conventional colorant color filters and plasmonic ACFs, or act as a highly transparent window under illumination with a different polarization, offering a new approach for high-definition transparent displays through actively controlling the polarization of incident light at each color pixel.

The theoretical simulations predict that ELT-based subtractive color filters in ultrathin nanogratings can achieve strong extinction within the resonance band, as well as high transmission peaks away from the resonance wavelength (i.e., 60˜70% for a duty cycle of 0.5). This peak transmission is significantly larger than that (7˜27%) of a closed Ag film of the same thickness. Moreover, since these structures are not optimized, further improvement may be possible, potentially achieving transmission values comparable to or even larger than that of commercial color filters. For example, we consider how the optical properties of plasmonic SCFs are affected by varying the grating duty cycle. The transmission away from the ELT resonance increases with the removal of highly-reflective Ag. Consequently, increasing the separation between neighboring Ag lines (i.e. varying the grating period while keeping the linewidth fixed) would further enhance the transmission efficiency. However, the near-field coupling between adjacent Ag lines may also become less efficient as the separation is increased, potentially reducing the effectiveness of SRSPP modes relative to LSPP modes and affecting the ELT minimum. Therefore, the nanograting parameters (such as line-width, separation between adjacent lines, and period) should be varied judiciously to achieve simultaneous optimization of the SCF transmission efficiency and the on-resonance extinction.

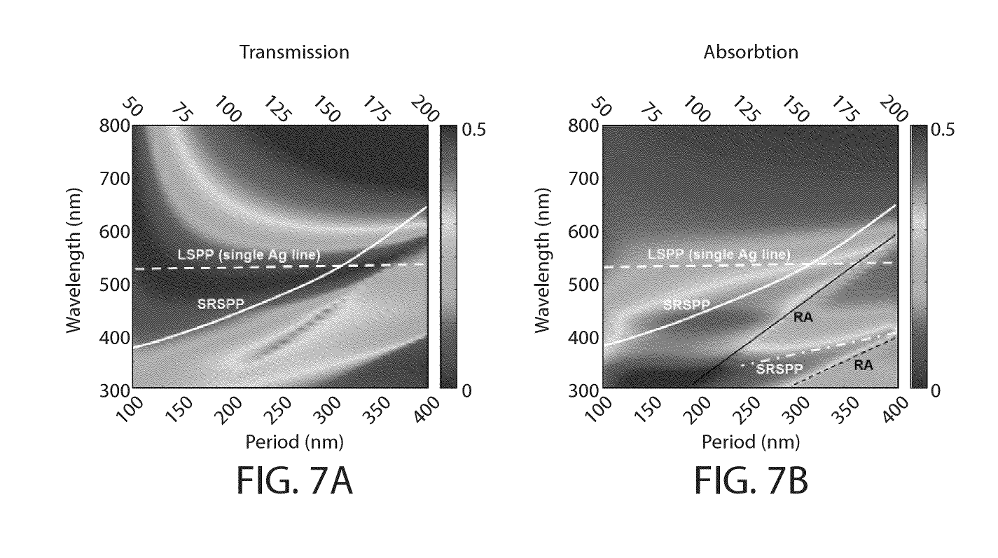

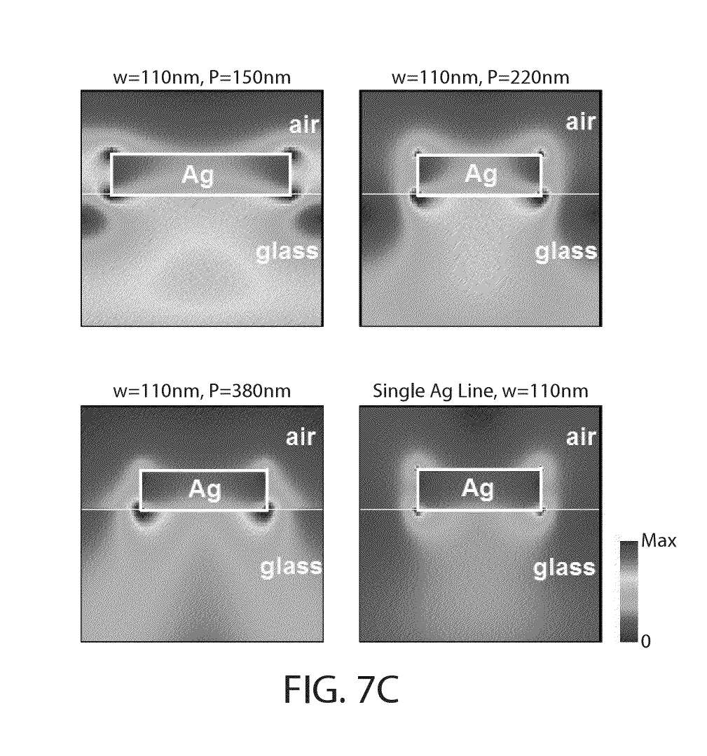

Since the excitation of propagating SRSPP modes relies on the effective coupling of electromagnetic modes between Ag lines, we performed FDTD simulations to study the optical properties of ultrathin Ag nanogratings with a constant line-width as a function of the separation between adjacent Ag lines. FIGS. 7A and 7B show 2D contour maps of the simulated transmission and absorption spectra for 30 nm-thick Ag nanogratings as a function of the incident wavelength and grating period, keeping the line-width of Ag wires fixed at 110 nm. For periods less than 150 nm, the broad transmission minimum in FIG. 7A in the 400 nm<λ<800 nm spectral region is primarily due to high optical reflection, since the separation between adjacent Ag lines (0˜40 nm) is very small. For nanogratings with P>150 nm, excitation of SRSPPs and LSPPs in ultrathin Ag nanogratings causes enhanced absorption and reflection that affect the transmission minimum. The spectral transmission minimum narrows and appears less dependent on P with increasing period, suggesting less effective excitation of SRSPPs as the separation between adjacent Ag lines increases.

FIG. 7B illustrates the contributions of three different mechanisms to absorption enhancement. For periods in the range 150 nm<P<250 nm, the separation between adjacent Ag lines ranges from 40 to 140 nm, and the absorption is mainly attributed to the excitation of SRSPP modes, as indicated by the analytical SRSPP dispersion curves (solid white curve). As the period increases further, the absorption spectra are closer to those predicted for LSPP modes (dashed white curve). For periods greater than 300 nm, the electromagnetic modes excited in individual Ag lines do not couple effectively with each other due to the large separation (>190 nm) between adjacent lines. Finally, for P>350 nm, RA modes (solid black curve) interact with SPPs, leading to a red-shift in absorption spectra.

The physical mechanisms for ELT are further illustrated by the calculated electric field distribution at the resonance wavelengths in these 30 nm-thick Ag nanogratings with a fixed 110 nm line-width. Grating periods of (i) 150 nm, (ii) 220 nm, and (iii) 380 nm, as well as (iv) a single Ag line were considered, and the results shown in FIG. 7C. For the 150 nm period (i), with a 40 nm separation between grating lines, the electromagnetic modes excited in neighboring Ag lines strongly interact with each other. Both LSPP and propagating SRSPP modes at the Ag/glass interface are clearly observed. For P=220 nm (ii), the electromagnetic coupling between adjacent Ag lines is weaker than that in (i), but the excitation of SRSPP modes is still observable. For the 380 nm period (iii), the SRSPP modes are much less evident due to the large separation (270 nm) between adjacent Ag lines, and the field distribution approaches that of a single Ag line in (iv), which shows primarily LSPP modes. Slight differences in the resonance wavelengths between (iii) and (iv) arise due to the RA at the glass/Ag interface.

Plasmonic SCF arrays with only two nanoslits surprisingly exhibited distinct subtractive colors, which can be understood in terms of the strong confinement properties of SRSPP and LSPP modes. Much of the electric field is concentrated in the metal film, resulting in strong Ohmic losses and short decay lengths. Because of the short propagation distance of SRSPPs and small decay length of LSPPs, interactions between neighboring nanostructures are weaker than those for EOT phenomenon, where SPPs excited at each nanoslit (or nanohole) strongly interact with numerous nearby nanoslits (or nanoholes). Fewer repeat units are required in the proposed plasmonics SCFs than are commonly employed in plasmonic ACFs based on EOT theory.

Although the present disclosure demonstrates polarization-dependent plasmonic subtractive color filtering with 1D ultrathin nanogratings in this work (i.e. nanoslits), it can be easily generalized to 2D ultrathin nanostructures (i.e. nanoholes or nanosquares) for achieving polarization-independent operation. Nevertheless, the 1D plasmonic SCFs, which can either function as color filters or highly transparent windows under different polarizations, making them highly attractive for transparent displaying. In traditional transparent displays, the RGB color pixels of the color filter are reduced to the minimum size for transparency. Display panel makers even remove the color filter, making the transparent display monochrome. Therefore, the low resolution and color gamut is a fundamental limitation in current transparent displaying techniques. The 1D plasmonic SCFs, which are capable of generating extremely small pixel sizes (˜0.5×0.3 μm²) for high spatial resolution, could significantly advance this application area.

Discrepancies between the experimental and numerical results can be attributed to the nonparallel incident light employed in the optical measurement, nanofabrication defects, finite periodicity in the fabricated structures, and surface roughness, which are not considered completely in numerical simulations. Although the experimental transmission minimum (6%) differs appreciably with the numerical value of 0.39% in FIG. 2, significant improvements should still be possible. The surface roughness (large grain size) in ultrathin Ag films is one of the factors that could significantly degrade the performance of plasmonic SCFs, possibly leading to measurement errors and non-uniform colors. Improved plasmonic SCF structures can be realized, for example, by introducing an intermediate (1 nm) Ge wetting layer before depositing Ag on the glass substrate or using template-stripping techniques, permitting ultra-smooth 30 nm-thick Ag films with smaller grain sizes for improved color filtering performance.

In summary, systematic theoretical and experimental studies were performed to clarify the underlying physical mechanisms that determine the ELT phenomenon. Different electromagnetic modes (SRSPPs, LSPPs, and RA) can be excited in ultrathin Ag nanogratings, depending on their geometric parameters. By exploiting ELT theory, we have proposed and demonstrated plasmonic SCFs associated with fundamentally different color filtering mechanisms than previous state-of-art plasmonic ACFs. The simple design, with its wide color tunability, ease of fabrication and device integration, as well as robustness and reliability, combines advances of SCFs and ultrathin plasmonic nanostructures to overcome key challenges in current colorant and plasmonic color filters. An unusually high transmission efficiency of 60˜70% has been achieved, with the potential for further enhancement. In addition, the proposed plasmonic SCFs are capable of generating even smaller pixel sizes than the smallest pixels achieved today in commercial image sensors. Finally, their unique polarization-dependent features allow the same structures to function either as color filters or highly-transparent windows under different polarizations, opening an avenue towards high-definition transparent displays. While only 1D nanograting structures have been demonstrated here, this design principle can be extended to 2D filter structures (e.g. nanogrids or nanohole) to achieve polarization-independent operation.

Two-dimensional (2D) filters comprising a film with a periodic array of rectilinear (i.e. nanogrids) or round nanoholes are operable to transmit color independent of the incident electromagnetic radiation polarization in all operating states. Such 2D filters are useful for multi-spectral imaging, infrared, and photographic applications. The 2D filters are formed similarly to the 1D nanogratings described herein and are comprised of a metal or non-metal film deposited on a substrate. The substrate may be transparent. For nanogrids, a gridded structure is formed on the substrate having a plurality of intersecting spaced apart line elements arranged perpendicular to each other forming openings therebetween with a checkerboard type pattern. Such nanogrids are disclosed for example in pending PCT International Application No. PCT/US14/32809 filed Apr. 3, 2014, which is incorporated herein by reference.

Although the present color filters have been described and demonstrated herein with respect to white light in the visible spectrum, the design can also be easily applied to other spectrum regimes for different applications including electromagnetic radiation ranging from ultraviolet through the terahertz regimes such as by selecting appropriate film materials and thicknesses sufficient to excite surface plasmonic resonances in these spectral regimes. It is well within the ambit of those skilled in the art to select such materials and thicknesses.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

What is claimed is:

1. A plasmonic subtractive color filter comprising:
a transparent substrate;
a nano-patterned metal film formed on the substrate; and
a plurality of elongated parallel nanoslits formed through the film, the nanoslits spaced apart at a pitch;
wherein the film is formed of a material having a thickness selected such that, when illuminated by light, surface plasmon resonances excited at top and bottom surfaces of the film interact and couple to form hybrid plasmon modes.

2. The color filter according to claim 1, wherein the film has a thickness having a high spectral light transmission efficiency in the range from about and including 60-70%.

3. The color filter according to claim 1, wherein when illuminated with light having a transverse-electric (TE) polarization, the film is transparent.

4. The color filter according to claim 1, wherein when illuminated with light having transverse-magnetic (TM) polarization, the film transmits light of a specific color.

5. The color filter according to claim 4, wherein changing the pitch between the nanoslits changes the color exhibited.

6. The color filter according to claim 5, wherein the film is operable to transmit cyan light through the film at a first pitch, magenta light through the film at a second pitch different than the first pitch, and yellow light through the film at a third pitch different than the first and second pitches.

7. The color filter according to claim 1, wherein the film has a thickness less than 100 nm.

8. The color filter according to claim 1, wherein the film has a thickness in the range from and including 10 to 50 nm.

9. The color filter according to claim 1, wherein the film has a thickness in the range from and including 20 to 30 nm.

10. The color filter according to claim 1, wherein the film is formed of silver.

11. The color filter according to claim 1, wherein the film is formed of a non-metal material.

12. The color filter according to claim 1, wherein the substrate is glass.

13. A plasmonic subtractive color filter comprising:
a transparent substrate;
a nanograting disposed on the substrate, the nanograting having a thickness selected to be semi-transparent allowing light to be transmitted through solid portions of the nanograting between the nanoslits such that a background image is at least partially visible through the nanograting; and
a plurality of elongated parallel nanoslits formed through the film, the nanoslits spaced apart at a first pitch;
wherein the film is formed of a material having a thickness selected such that, when illuminated by light, surface plasmon resonances excited at top and bottom surfaces of the film interact and couple to form hybrid plasmon modes.

14. The color filter according to claim 13, wherein when illuminated with light having a transverse-electric (TE) polarization, the film is transparent, and when illuminated with light having transverse-magnetic (TM) polarization, the film transmits light of a specific color.

15. The color filter according to claim 13, wherein the nanograting has a thickness less than 100 nm.

16. The color filter according to claim 13, wherein the nanograting is formed of silver.

17. A transparent display system comprising:
a transparent substrate;
a first nanograting disposed on the substrate, the nanograting formed of a material selected such that, when illuminated by light, surface plasmon resonances excited at top and bottom surfaces of the film interact and couple to form hybrid plasmon modes; and
a plurality of elongated parallel nanoslits formed through the first nanograting, the nanoslits spaced apart at a first pitch spacing;
wherein when the light has a first polarization, the first nanograting transmits a first transmitted color and retains a first absorbed color; and
wherein when the light has a second polarization, the first nanograting is transparent.

18. The display system according to claim 17, further comprising an array of multiple nanogratings formed in a pattern on the transparent substrate.

19. The display system according to claim 18, wherein at least one second nanograting of the array has nanoslits with a second pitch spacing, wherein when illuminated by light of the first polarization, the second nanograting transmits a second transmitted color through the second nanograting and retains a second absorbed color, the second transmitted color being different than the first transmitted color of the first nanograting.

20. The display system according to claim 17, wherein the nanograting has a thickness less than 100 nm

21. The display system according to claim 17, wherein the first nanograting is formed of metal.

22. A two-dimensional plasmonic filter comprising:
a transparent substrate;
a nano-patterned film formed on the substrate; and
a periodic array of rectilinear or round nanoholes formed through the film;
wherein the film is formed of a material having a thickness selected such that, when illuminated by light, surface plasmon resonances excited at top and bottom surfaces of the film interact and couple to form hybrid plasmon modes.

23. The filter of claim 22, wherein the filter is tunable to transmit bands of electromagnetic radiation from ultraviolet to microwave wavelengths.

24. The filter of claim 23, wherein the electromagnetic radiation is in the visible spectrum of wavelengths and the film transmits a specific color.
